(19) United States
(12) Patent Application Publication
(10) Pub. No.: US 2004/0121830 A1
(43) Pub. Date: Jun. 24, 2004

(54) Enigma-X

(76) Inventor: Jeremy Frank Alessi, Virginia Beach, VA (US)

Correspondence Address: Jeremy Alessi, 2237 Creeks Edge Drive, Virginia Beach, VA, 23451, US

(21) Appl. No.: 10/260,622

(22) Filed: Dec. 20, 2002

(51) Int. Cl. A63F 13/00

(52) U.S. Cl. 463/9

(57) ABSTRACT

Enigma-X is a game that has 3 pieces that can come under control of the player. These 3 pieces each have special interaction properties that allow them to be removed from the screen and award the player with points. It's a very simple game that could be reproduced on a cell phone, a calculator, a PDA, any game console, or a computer. I have included the source code from the Windows PC version of the game. The interaction between the pieces is what makes the game special.

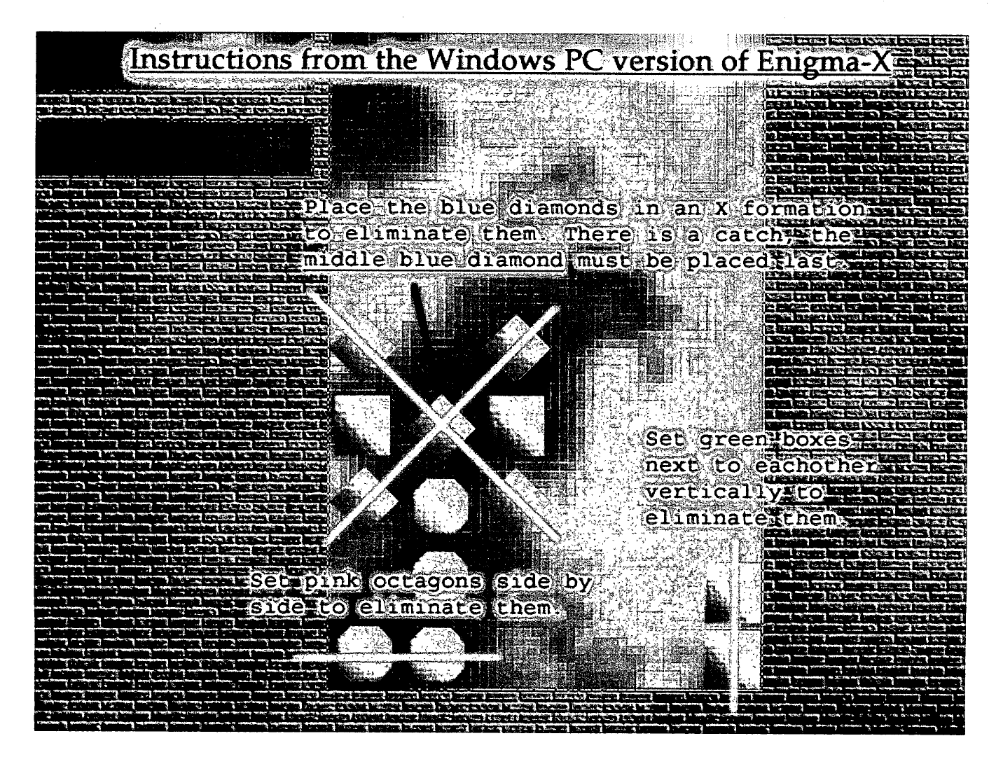

Enigma-X is an electronic puzzle game that contains 3 distinct entities.

The object of the game is to eliminate the entities from an on-screen game board. Each of the 3 entities must be eliminated differently. The first of the 3 will be called type “A” for this specification and the others will be called “B” and “C”. Placing a type “A” entity vertically adjacent to other entities of type “A” eliminates them. Type “B” is similar except they must be placed horizontally adjacent to other entities of type “B” to be eliminated. Type “C” must be placed in an X-formation to be eliminated. The instructions diagram included with this specification only identifies one way the X-formation can be completed. The programmer could create different modes of play, where the last type “C” entity to be placed is not the center type “C” entity. The programmer could also create the same gameplay where the 3 entities don't move from the top of the display to the bottom, but in other directions. For example, the entities could begin on the left end of the screen and move to the right end of the screen.

[image]

[image]

[image]

[image]

[image]

[image]

[image]

[image]

[image]

[image]

[image]

[image]

[image]

[image]

[image]

[image]

[image]

[image]

[image]

What I claim as my invention is

1. An electronic game that can be played on any electronic device with a graphical display.

2. The electronic game mentioned in claim 1 contains 3 controllable entities that are to be placed by the player in a certain manner to reward the player and advance the game.

4. The manner in which the 3 entities from claim 2 can be placed is this. Entity A can be placed vertically adjacent to other entities of type A to eliminate them and advance the game. Entity B can be placed horizontally adjacent to other entities of type B to eliminate them and advance the game. Entity C must be arranged with 4 other type C entities in an “X” formation to eliminate them and advance the game. For example if these entities were placed on the Cartesian plane one type C entity is at location (1,1). It should be surrounded by other type C entities at locations (0,0), (0,2), (2,0), and (2,2).

5. The game/invention can be programmed so that variation with respect for how the “X” can be formed with the type C entities. For example one game mode might only allow the game to advance when the center section (1,1) of the “X” mentioned in claim 3 is inserted after the other 4 type C entities are in place.
